(19) United States
(12) Patent Application Publication
(10) Pub. No.: US 2017/0277997 A1
(43) Pub. Date: Sep. 28, 2017

(54) Invariants Modeling and Detection for Heterogeneous Logs

(71) Applicant: NEC Laboratories America, Inc., Princeton, NJ (US)

(72) Inventors: Bo Zong, Plainsboro, NJ (US); Jianwu Xu, Lawrenceville, NJ (US); Guofei Jiang, Princeton, NJ (US)

(21) Appl. No.: 15/430,024

(22) Filed: Feb. 10, 2017

Related U.S. Application Data
(60) Provisional application No. 62/312,035, filed on Mar. 23, 2016.

(51) Int. Cl. G06N 5/02; G06N 99/00

(52) U.S. Cl. CPC G06N 5/02; G06N 99/005

(57) ABSTRACT

A method is provided that is performed in a network having nodes that generate heterogeneous logs including performance logs and text logs. The method includes performing, during a heterogeneous log training stage, (i) a log-to-time sequence conversion process for transforming clustered ones of training logs, from among the heterogeneous logs, into a set of time sequences that are each formed as a plurality of data pairs of a first configuration and a second configuration based on cluster type, (ii) a time series generation process for synchronizing particular ones of the time sequences in the set based on a set of criteria to output a set of fused time series, and (iii) an invariant model generation process for building invariant models for each time series data pair in the set of fused time series. The method includes controlling an anomaly-initiating one of the plurality of nodes based on the invariant models.

### RELATED APPLICATION INFORMATION

This application claims priority to provisional application Ser. No. 62/312,035 filed on Mar. 23, 2016, incorporated herein by reference.

### BACKGROUND

Technical Field

The present invention relates to data processing, and more particularly to invariant modeling and detection for heterogeneous logs.

Description of the Related Art

Information Technology (IT) systems include a large number of functional components, and these components have dependencies between each other. In such complex systems, heterogeneous log data is generated from individual components, where dependencies between components remain hidden. While invariant analysis has been widely adopted to discover hidden relations in time series data, it is difficult to apply existing tools over heterogeneous logs that are generated from multiple log sources. The key problem is the set of time series derived by logs from different sources are not synchronized. For example, (1) time periods covered by different time series are not aligned; and (2) different time series employ different sampling frequency. Therefore, there is a need for an approach for invariant modeling and detection for heterogeneous logs.

### SUMMARY

These and other drawbacks and disadvantages of the prior art are addressed by the present invention.

According to an aspect of the present invention, a method is provided that is performed in a network having a plurality of nodes that generate heterogeneous logs including performance logs and text logs. The method includes performing, by a processor during a heterogeneous log training stage, (i) a log-to-time sequence conversion process for transforming clustered ones of training logs, from among the heterogeneous logs, into a set of time sequences that are each formed as a plurality of data pairs of a first configuration and a second configuration based on cluster type, (ii) a time series generation process for synchronizing particular ones of the time sequences in the set based on a set of criteria to output a set of fused time series, and (iii) an invariant model generation process for building invariant models for each time series data pair in the set of fused time series. The method further includes controlling, by the processor, an anomaly-initiating one of the plurality of nodes based on an output of the invariant models.

According to another aspect of the present invention, a computer program product is provided for invariant model formation for a network having a plurality of nodes that generate heterogeneous logs including performance logs and text logs. The computer program product includes a non-transitory computer readable storage medium having program instructions embodied therewith. The program instructions are executable by a computer to cause the computer to perform a method. The method includes performing, by a processor during a heterogeneous log training stage, (i) a log-to-time sequence conversion process for transforming clustered ones of training logs, from among the heterogeneous logs, into a set of time sequences that are each formed as a plurality of data pairs of a first configuration and a second configuration based on cluster type, (ii) a time series generation process for synchronizing particular ones of the time sequences in the set based on a set of criteria to output a set of fused time series, and (iii) an invariant model generation process for building invariant models for each time series data pair in the set of fused time series. The method further includes controlling, by the processor, an anomaly-initiating one of the plurality of nodes based on an output of the invariant models.

According to yet another aspect of the present invention, a computer processing system is provided for invariant model formation for a network having a plurality of nodes that generate heterogeneous logs including performance logs and text logs. The computer processing includes a processor. The processor is configured to perform, during a heterogeneous log training stage, (i) a log-to-time sequence conversion process for transforming clustered ones of training logs, from among the heterogeneous logs, into a set of time sequences that are each formed as a plurality of data pairs of a first configuration and a second configuration based on cluster type, (ii) a time series generation process for synchronizing particular ones of the time sequences in the set based on a set of criteria to output a set of fused time series, and (iii) an invariant model generation process for building invariant models for each time series data pair in the set of fused time series. The processor is further configured to control an anomaly-initiating one of the plurality of nodes based on an output of the invariant models.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an exemplary processing system 100 to which the present principles may be applied, according to an embodiment of the present principles;

FIGS. 2-3 show exemplary heterogeneous logs 200 to which the present invention can be applied, in accordance with an embodiment of the present invention;

FIGS. 4-5 show an exemplary detected anomaly 401 from heterogeneous logs 400 to which the present invention can be applied, in accordance with an embodiment of the present invention;

FIG. 6 shows an exemplary system/method 600 for Invariant Model based Correlation Analysis over Heterogeneous Logs (IMCAHL), in accordance with an embodiment of the present invention;

FIG. 7 further shows the logs-to-time sequence conversion block 602 of FIG. 6, in accordance with an embodiment of the present invention;

FIG. 8 shows time sequences 800 for the logs in FIG. 2 that match the log schemas, in accordance with an embodiment of the present invention;

FIG. 9 further shows the time series generation block 603 of FIG. 6, in accordance with an embodiment of the present invention;

FIG. 10 shows the time series 1000 obtained from the time sequences in FIG. 8, in accordance with an embodiment of the present invention;

FIG. 11 further shows the invariant model generation block 604 of FIG. 6, in accordance with an embodiment of the present invention;

FIG. 12 shows an invariant model 1200 for the pair of log clusters shown in FIG. 10, in accordance with an embodiment of the present invention;

FIG. 13 further shows the logs-to-time sequence conversion block 606 of FIG. 6, in accordance with an embodiment of the present invention;

FIG. 14 further shows the time series generation block 607 of FIG. 6, in accordance with an embodiment of the present invention;

FIG. 15 further shows the time series generation block 608 of FIG. 6, in accordance with an embodiment of the present invention; and

FIG. 16 shows a block diagram of an exemplary environment 1600 to which the present invention can be applied, in accordance with an embodiment of the present invention.

### DETAILED DESCRIPTION OF PREFERRED EMBODIMENTS

The present invention is directed to invariant modeling and detection for heterogeneous logs.

The present invention provides an approach that fuses heterogeneous logs into synchronized time series data so that the following can be performed: invariant analysis; uncover hidden component dependencies; and enable outlier detection.

To perform invariant analysis over heterogeneous logs in, for example, IT systems and so forth, the present invention addresses the issue that log data is typically encoded in diverse formats with multiple data types. Therefore, the present invention provides a principled approach that integrates heterogeneous logs into a standard data structure for invariant analysis.

In an embodiment, the present invention provides a principled approach to discover (i) underlying invariants across time series extracted from heterogeneous text logs and system performance time series from multiple log sources, and (ii) detect any system anomalies based on the invariant analysis through machine learning methods. The present invention transforms heterogeneous logs into multi-dimensional time series, and performs fast and robust invariant analysis among the time series. In an embodiment, to address the time series synchronization problem in heterogeneous logs, the present invention first provides a time window generation method that creates a common set of sampling time points shared among all of the time series, and then applies a resampling procedure that fills reasonable values for the sampling time points. The correlation analysis mechanism is based on an invariant model with a fitness score as the parameter, where both modeling and testing are performed by linear algorithms given a pair of time series.

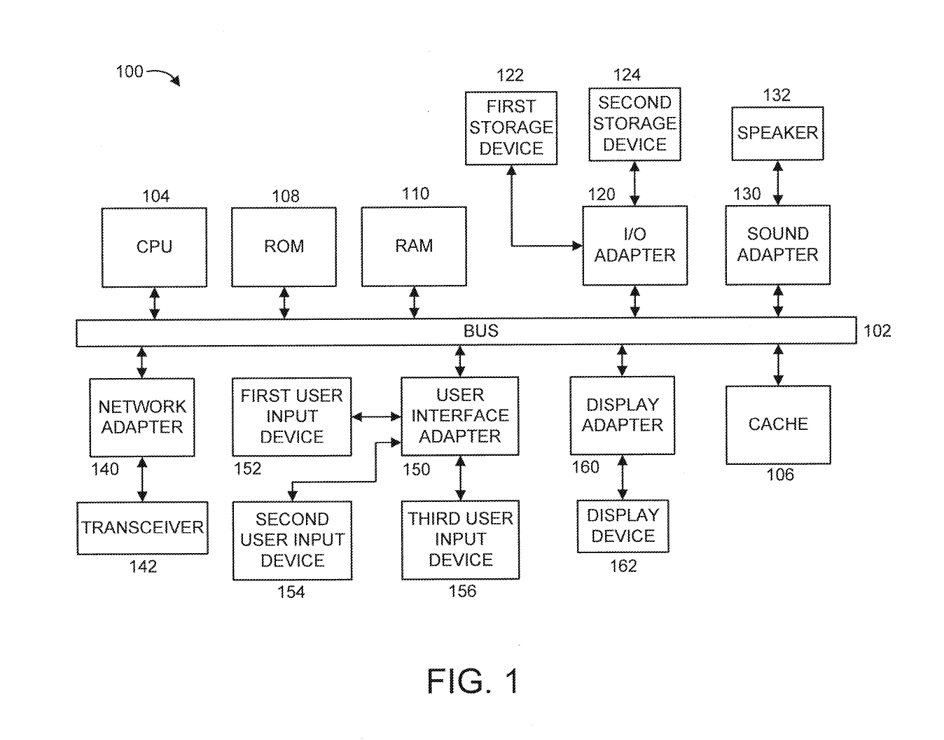

Referring now in detail to the figures in which like numerals represent the same or similar elements and initially to FIG. 1, a block diagram illustrating an exemplary processing system 100 to which the present principles may be applied, according to an embodiment of the present principles, is shown. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

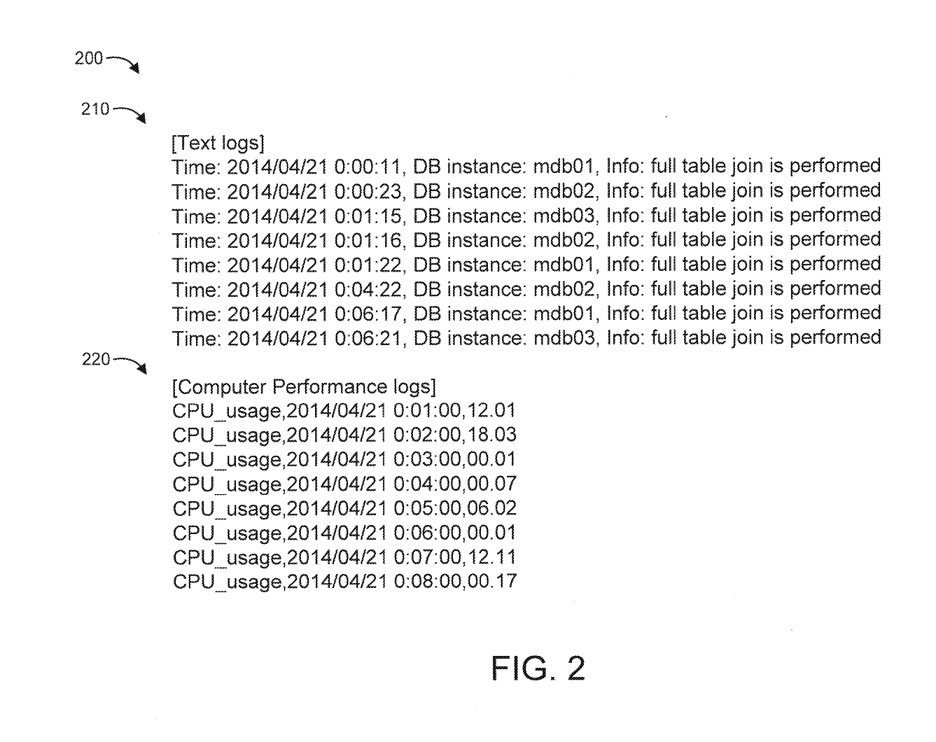

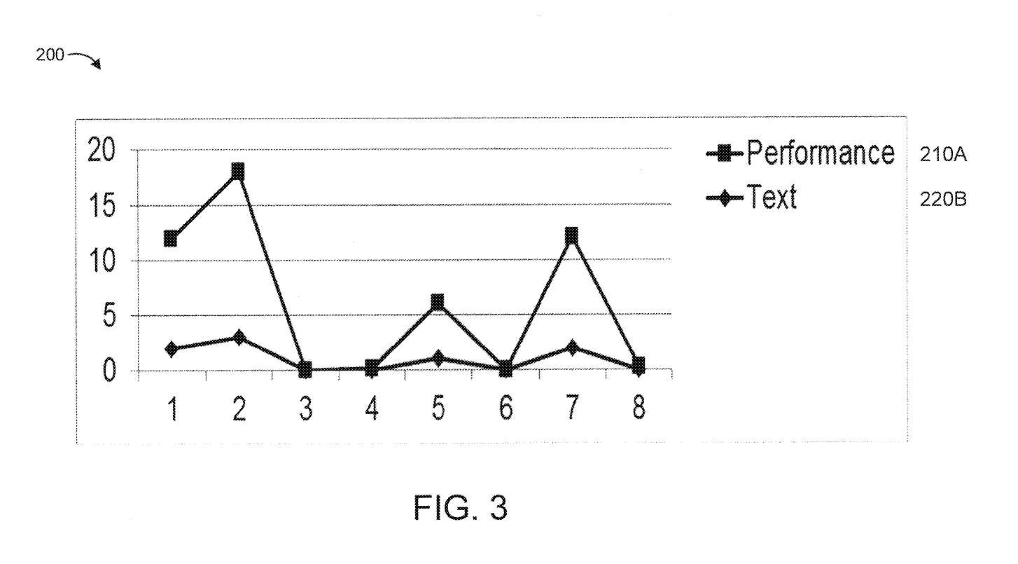

FIGS. 2-3 show exemplary heterogeneous logs 200 to which the present invention can be applied, in accordance with an embodiment of the present invention. The heterogeneous logs 200 include heterogeneous text logs 210 and heterogeneous performance logs 220 (FIG. 2), as well as respective plots 210A and 220A (FIG. 3) of the heterogeneous text logs 210 and heterogeneous performance logs 220.

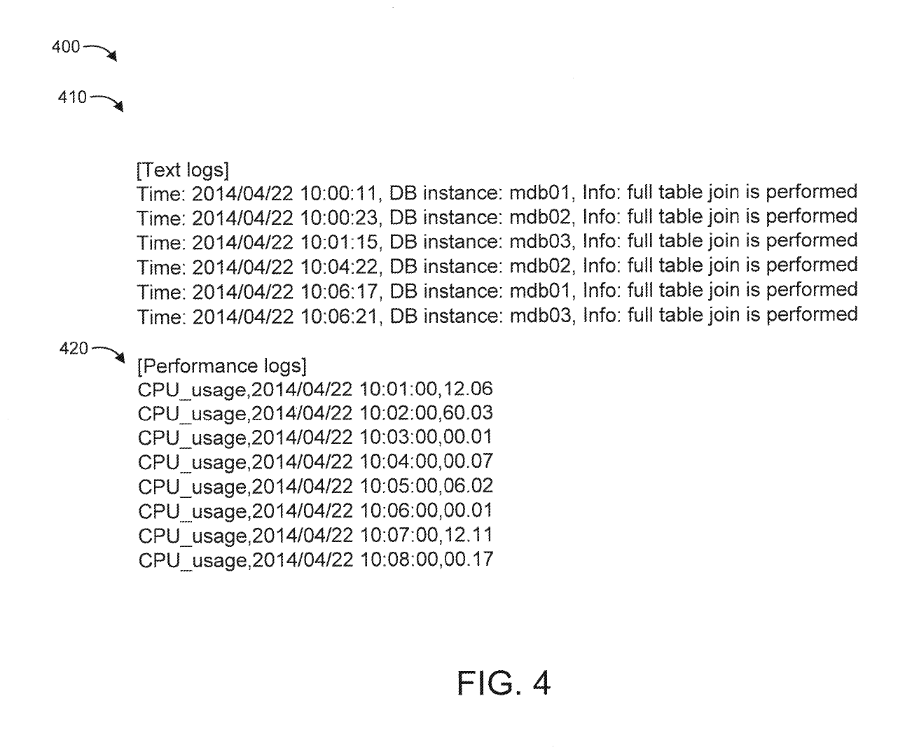

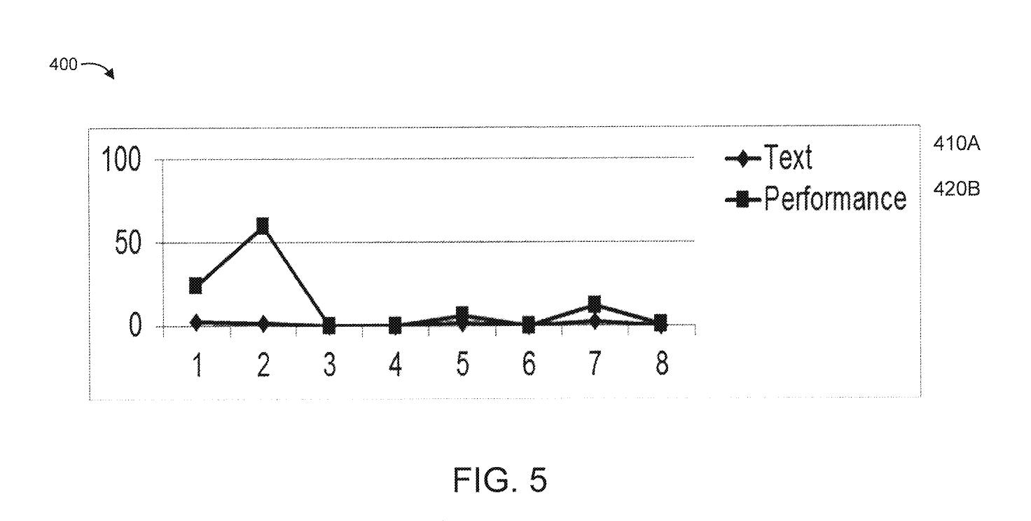

FIGS. 4-5 show an exemplary detected anomaly 401 from heterogeneous logs 400 to which the present invention can be applied, in accordance with an embodiment of the present invention. The heterogeneous logs 400 include heterogeneous text logs 410 and heterogeneous performance logs 420 (FIG. 4), as well as respective plots 410A and 420A (FIG. 5) of the heterogeneous text logs 410 and heterogeneous performance logs 420.

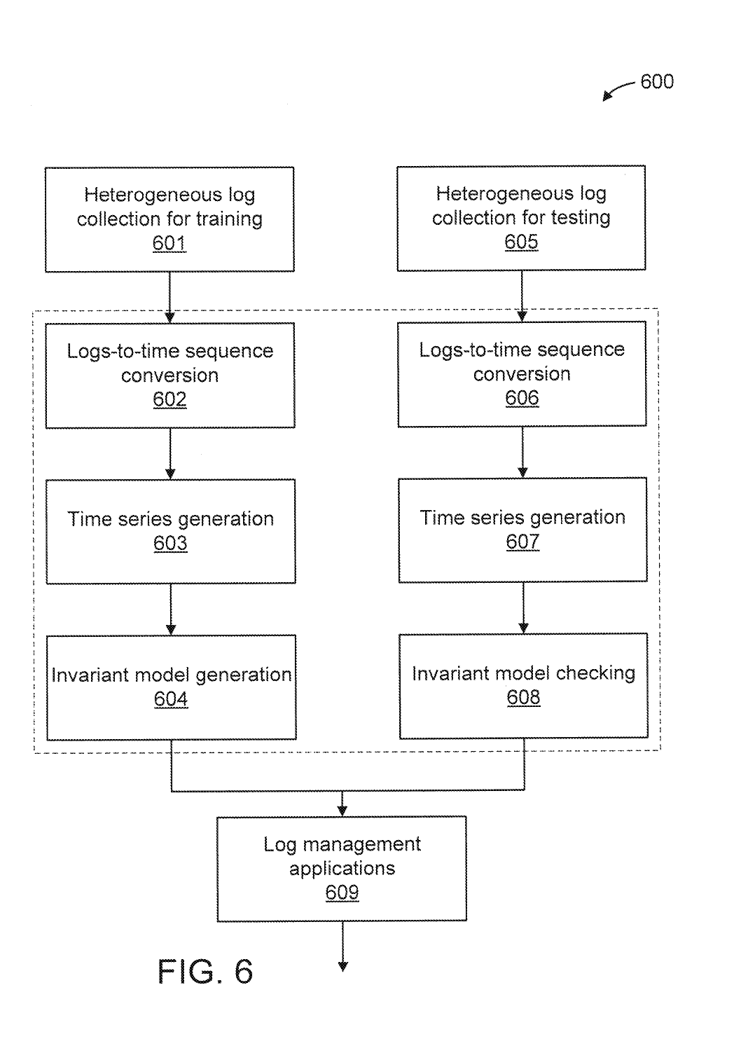

FIG. 6 shows an exemplary system/method 600 for Invariant Model based Correlation Analysis over Heterogeneous Logs (IMCAHL), in accordance with an embodiment of the present invention.

The system/method 600 includes a heterogeneous log collection for training block 601 and a heterogeneous log collection for testing block 605, and a log management applications block 609.

Relating to the heterogeneous log collection for training block 601, the system/method 600 includes a logs-to-time sequence conversion block 602, a time series generation block 603, and an invariant model generation block 604.

Relating to the heterogeneous log collection for testing block 605, the system/method 600 includes a logs-to-time sequence conversion block 606, a time series generation block 607, and an invariant model checking block 608.

The heterogeneous log collection for training block 601 takes heterogeneous logs from arbitrary/unknown systems or applications. The heterogeneous logs can be obtained from one source (single source from single IT server), or can be obtained from multiple sources (multiple log sources from multiple IT servers). A log message includes a time stamp and the text content with one or multiple fields.

The logs to time sequence conversion block 601 transforms original training text logs into a set of time sequence data.

The time series generation block 603 synchronizes the set of time sequences output by 602 and outputs time series for the input time sequences.

The invariant model generation block 604 analyzes the set of time series output by 603, and builds invariant models for each pair of time series.

The heterogeneous log collection for testing block 605 takes heterogeneous logs collected from the same system in block 601 for invariant model testing. A log message includes a time stamp and the text content with one or multiple fields. The testing data may come in one batch as a log file, or come in a stream process.

The logs to time sequence conversion block 606 transforms original testing text logs into a set of time sequence data.

The time series generation block 607 synchronizes the set of time sequences output by block 606 and output time series for input time sequences.

The invariant model checking block 608 analyzes the set of time series data output by block 607 based on the corresponding invariant models output by block 604, and outputs anomalies on any time series data point violating the invariant model and the related log messages.

The log management application block 609 applies a set of management applications onto the heterogeneous logs from block 601 based on the invariant models output by block 603, or onto the heterogeneous logs from block 604 based on the invariant model checking output by block 606. For example, invariant models output by block 603 can be applied to analyze hidden dependency within a target system, and anomalies output by block 606 can be used to detect unexpected system workload or behavior changes. Moreover, based on the detection of an anomaly using an invariant model, an anomaly-initiating one of a plurality of nodes (e.g., a computer in a cluster of computers, and so forth) can be controlled. In an embodiment, the control can involve powering down a root cause computer processing device at the anomaly-initiating one of the plurality of nodes to mitigate an error propagation therefrom. In an embodiment, the control can involve terminating a root cause process executing on a computer processing device at the anomaly-initiating one of the plurality of nodes to mitigate an error propagation therefrom.

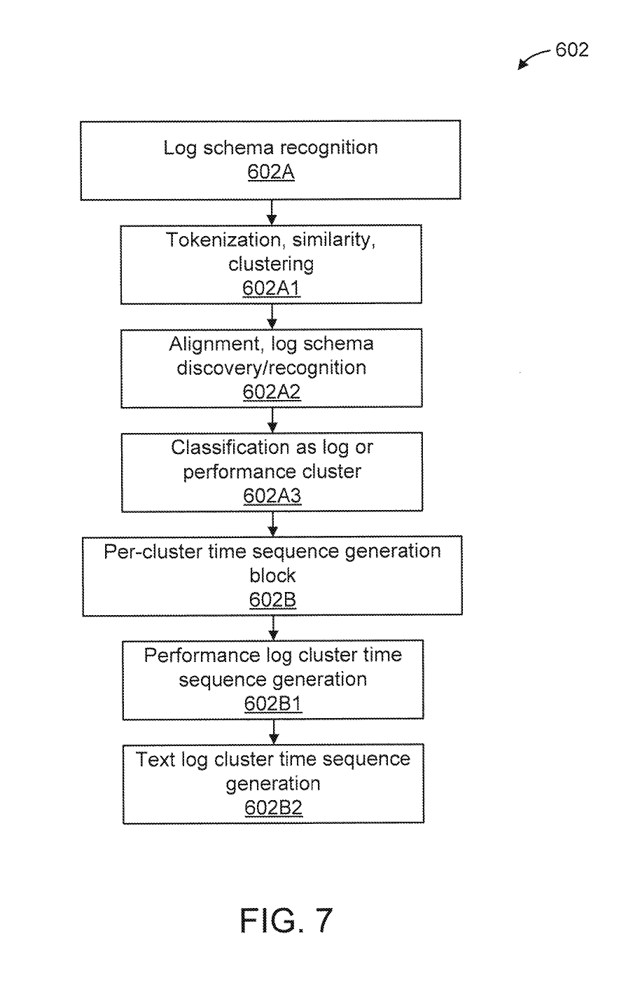

FIG. 7 further shows the logs-to-time sequence conversion block 602 of FIG. 6, in accordance with an embodiment of the present invention.

The logs-to-time sequence conversation block 602 includes a log schema recognition block 602A and a per-cluster time sequence generation block 602B.

Regarding the log scheme recognition block 602A, a set of log schemas matching the training logs can be provided by users directly, or generated automatically by a pattern recognition procedure on all the heterogeneous logs as follows in block 602A1-602A3:

Block 602A1: tokenization, similarity, clustering;
Block 602A2: alignment, log schema discovery/recognition; and
Block 603A3: classification as log or performance cluster.

At block 602A1 (tokenization; similarity; clustering), taking arbitrary heterogeneous logs (from step 601 of FIG. 6), a tokenization process is performed so as to generate semantically meaningful tokens from logs. After tokenization, a similarity measurement on heterogeneous logs is applied. This similarity measurement leverages both the log layout information and log content information, and it is specially tailored to arbitrary heterogeneous logs. Once the similarities among logs are obtained, a log clustering algorithm can be applied so as to generate and output log clusters. IMCAHL allows users to plug in their favorite clustering algorithms.

At block 602A2 (alignment; log schema discovery/recognition), once the logs are clustered, the logs are also aligned within each cluster. The log alignment is designed to preserve the unknown layouts of heterogeneous logs so as to help log schema recognition in the following steps. Once the logs are aligned, log schema discovery is conducted so as to find the most representative layouts and log fields.

The following steps show how we perform log field recognition. First, fields such as time stamps, Internet Protocol (IP) addresses, and universal resource locators (URLs) are recognized based on prior knowledge about their syntax structures. Second, fields which are highly stable in the logs are recognized as general constant fields in log schemas. Third, the rest fields are recognized as general variable fields, including number fields, hybrid string fields, and string fields.

At block 602A3 (classification as log or performance cluster), we classify log clusters as text log clusters and performance log clusters. A cluster is a performance log cluster, if its log schema contains three fields. The first field is a constant field indicating performance metric names, the second field is time stamp field, and the third field is number field. If a cluster is not a performance log cluster, then it is a text log cluster. For example, log messages about CPU usage are usually grouped into a performance log cluster, and one such message could be “CPU_usage, 2015/5/17 01:30:20, 60.72”.

Regarding the per-cluster time sequence generation block 602B, within one cluster, logs share a common log schema and are taken as same type of logs. We generate time sequences for each log cluster as follows per block 602B1 and 602B2:

602B1: performance log cluster time sequence generation; and
602B2: text log cluster time sequence generation.

At block 602B1, for a performance log cluster, we generate its time sequence as follows. First, we order log messages in the cluster. Second, we extract values in the time stamp and the number fields, and build a tuple (X, Y) for each log message, where X is the value in its time stamp field and Y is the value in its number field. Assume we have k log messages. After this step, we obtain a time sequence s=<(X₁, Y₂), . . . , (Xₖ, Yₖ)>, where X₁<X₂< . . . <Xₖ.

At block 602B2, for a text log cluster, we generate its time sequence as follows. First, we order log messages in the cluster. Second, we extract values in the time stamp field, and build a tuple (X, 1) for each log message, where X is the value in its time stamp field and 1 indicates such kind of logs occur once at time X. Assume we have k log messages. After this step, we obtain a time sequence s=<(X₁, 1), . . . , (Xₖ, 1)>, where X₁<X₂< . . . <Xₖ.

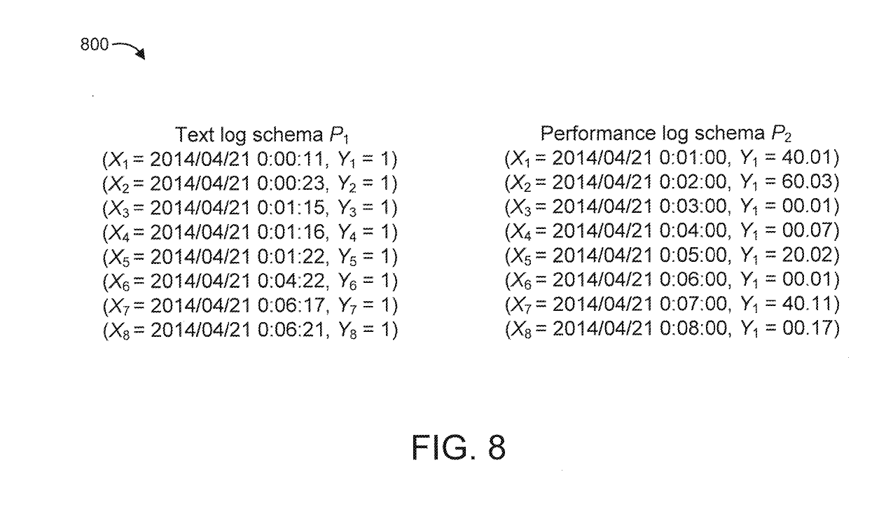

FIG. 8 shows time sequences 800 for the logs in FIG. 2 that match the log schemas, in accordance with an embodiment of the present invention. That is, FIG. 8 shows an example of IMCAHL time sequence data for the logs in FIG. 2, in accordance with an embodiment of the present invention.

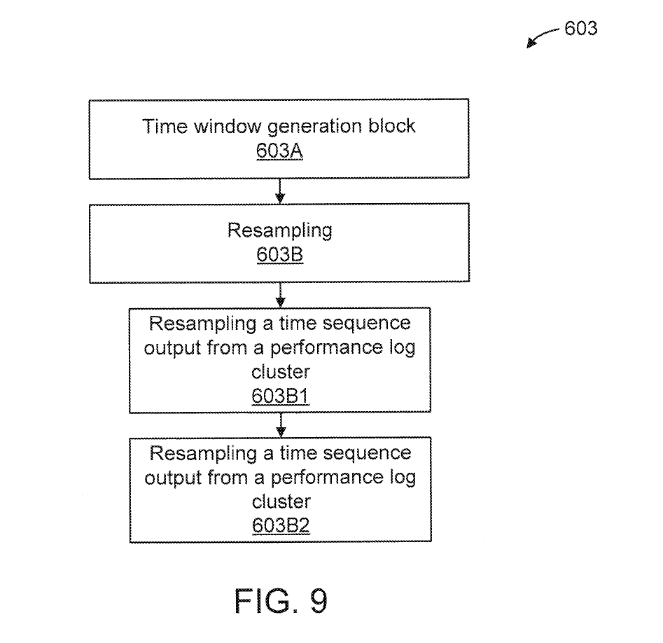

FIG. 9 further shows the time series generation block 603 of FIG. 6, in accordance with an embodiment of the present invention.

The time series generation block 603 includes a time window generation block 603A and a resampling block 603B.

For each log cluster/schema, we obtain a time sequence s=<(X₁, Y₁), (X₂, Y₂), . . . , (Xₖ, Yₖ)> output from 602B (see FIG. 7), the following is time series generation procedure that fuses multiple time sequences into multiple time series that share identical sampling time and frequency. Given a user-define time window size w, we perform time series generation as follows.

Regarding the time window generation block 603A, take the time domain as a one-dimensional space, which starts at epoch time 0 (i.e., 1970/1/1 00:00:00) and goes into the infinite future. We partition time domain into time windows with identical size, where the duration of a time window is w.

Regarding the resampling block 603B, we denote a time window W as a time range [tₛ, tₑ], where tₛ is the starting time point of W and tₑ is the end time point of W. Note that time point tₛ is not included in W so that time windows are disjoint. Given a time sequence s=<(X₁, Y₁), . . . , (Xₖ, Yₖ)>, we identify a sequence of time windows <W₁, W₂, . . . , Wₘ> that fully covers time stamps {X₁, X₂, . . . , Xₖ}.

The resampling block 603B can involve:

603B1: resampling a time sequence output from a performance log cluster; and
603B2: resampling a time sequence output from a text log cluster of log schema P.

At block 603B1 (for a time sequence output from a performance log cluster), we transform s=<(X₁, Y₁), . . . , (Xₖ, Yₖ)> into time series ts=<(X′₁, Y′₁), . . . , (X′ₘ, Y′ₘ)>. In ts, X′ᵢ is the end time point of Wᵢ, and Y′ᵢ is obtained by performing linear interpolation at X′ᵢ based on s.

At block 603B2 (for a time sequence output from a text log cluster of log schema P), we transform s=<(X₁, Y₁), . . . , (Xₖ, Yₖ)> into time series ts=<(X′₁, Y′₁), . . . , X′ₘ, Y′ₘ)>. In ts, X′ᵢ is the end time point of Wᵢ, and Y′ᵢ is the number of log messages that match log schema P within time window Wᵢ.

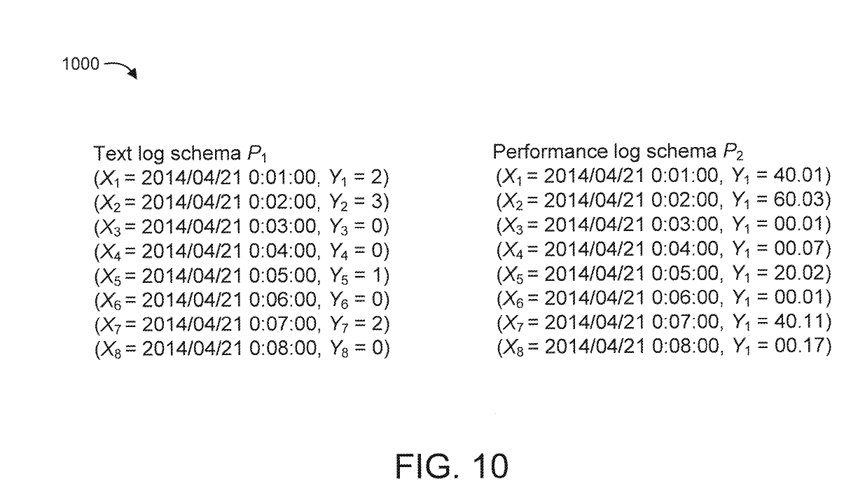

FIG. 10 shows the time series 1000 obtained from the time sequences in FIG. 8, in accordance with an embodiment of the present invention.

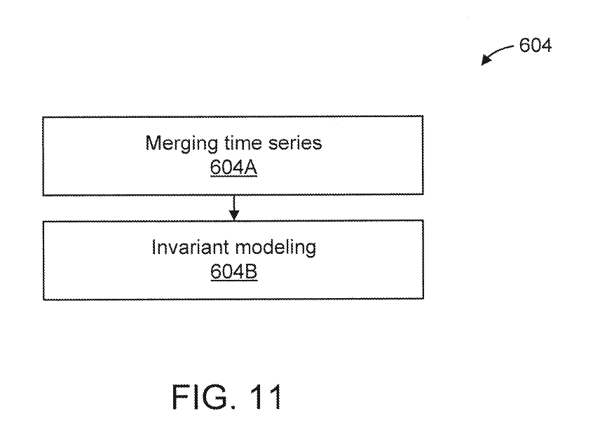

FIG. 11 further shows the invariant model generation block 604 of FIG. 6, in accordance with an embodiment of the present invention.

The invariant model generation block 604 includes a merging time series block 604A and an invariant modeling block 604B.

For the set of time series output from block 603B of FIG. 9, the following is the invariant model generation procedure that produces invariant models for log cluster pairs.

Regarding merging time series block 604A, we collect the set of time series output from block 602, and merge them into a multi-dimensional time series.

Regarding the invariant modeling block, with the multi-dimensional time series, we utilize existing correlation analysis tools, such as SLAT (System Invariants Analysis Technology) to generate invariant models for log cluster pairs. In particular, in an embodiment, we filter out invariants whose fitness score is no more than 0.7.

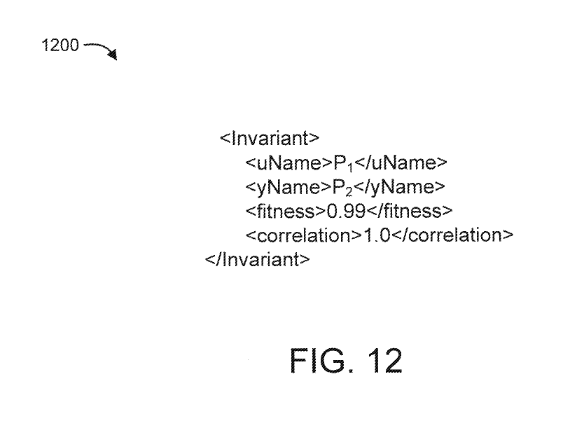

FIG. 12 shows an invariant model 1200 for the pair of log clusters shown in FIG. 10: one is the text log cluster with schema P₁, and the other is the performance log cluster with schema P₂.

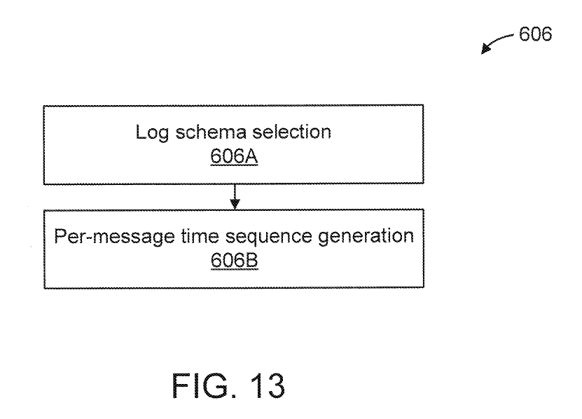

FIG. 13 further shows the logs-to-time sequence conversion block 606 of FIG. 6, in accordance with an embodiment of the present invention.

The logs-to-time sequence conversion block 606 includes a log schema selection block 606A and a per-message time sequence generation block 606B.

Regarding the log schema selection block 606A, from the set of log schemas generated from block 601, only the schemas with invariant models are selected for the rest of the testing procedure.

Regarding the per-message time sequence generation block 606B, for each log message i in the testing data, find the log schema P it matches (e.g., through a regular expression testing), and extract its time stamp Xᵢ. If P is a text log schema, this block 606B outputs a tuple (Xᵢ, 1) for this message; if P is a performance log schema, this block 606B outputs a tuple (Xᵢ, Yᵢ) for this message, where Yᵢ is the value of the number field in this message.

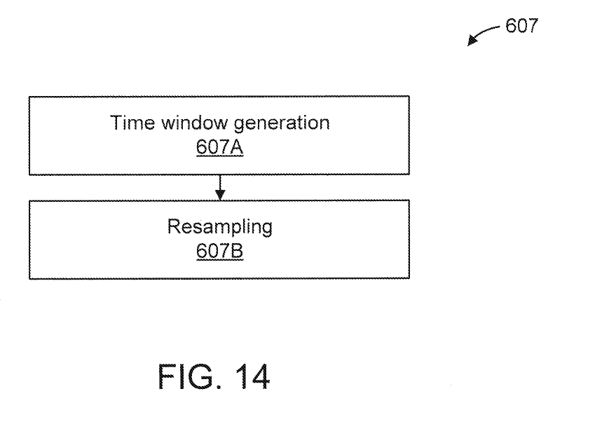

FIG. 14 further shows the time series generation block 607 of FIG. 6, in accordance with an embodiment of the present invention.

For each log schema, we obtain a time sequence s=<(X₁, Y₁), (X₂, Y₂), . . . , (Xₖ, Yₖ)> output from block 606B (see FIG. 13), the following is time series generation procedure that fuses multiple time sequences into multiple time series that share identical sampling time and frequency. Given a user-define time window size w, we perform time series generation as follows per blocks 1407A and 1407B.

The time series generation block 607 includes a time window generation block 607A and a resampling block 607B.

Regarding the time window generation block 607A, time windows are generated following the same approach in block 603A (see FIG. 9).

Regarding the sampling block 607B, the block is performed following the approach from block 603B in FIG. 9 over both time sequences for text log schemas and time sequences for performance schema. For each time sequence, this block 670B outputs its corresponding time series.

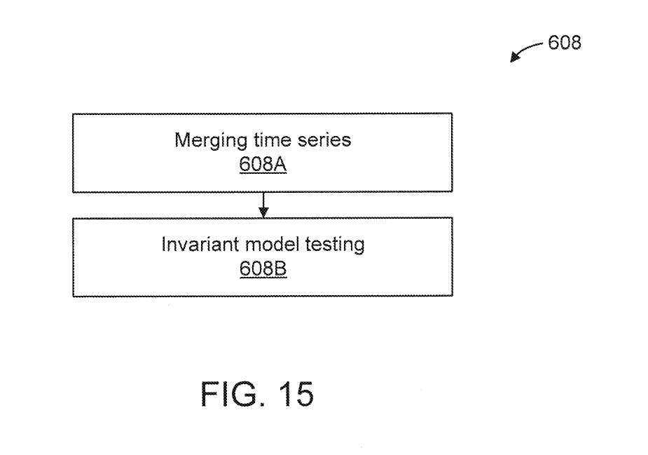

FIG. 15 further shows the time series generation block 608 of FIG. 6, in accordance with an embodiment of the present invention.

For a pair of log schemas with invariant models, the following is the invariant model testing procedure to decide if it violates correlation patterns learned from training data. An anomaly will be reported if such violation exists.

The time series generation block 608 includes a merging time series block 608A and an invariant model testing block 608B.

Regarding the merging time series block 608A, the set of time series output from block 607B (see FIG. 14) is collected and merged into a multi-dimensional time series.

Regarding the invariant model testing block 608B, with the multi-dimensional time series, we utilize existing correlation analysis tools, such as SLAT, to test if invariant models are broken for time series output by 801. When broken invariants are detected, anomalies are reported.

The following shows the three periodicity anomalies detected from the logs in FIG. 4 based on the invariant model learned from the logs in FIG. 2:

Invariant between P1 and P2 is broken, detected at time 2014/4/22 10:02:00.

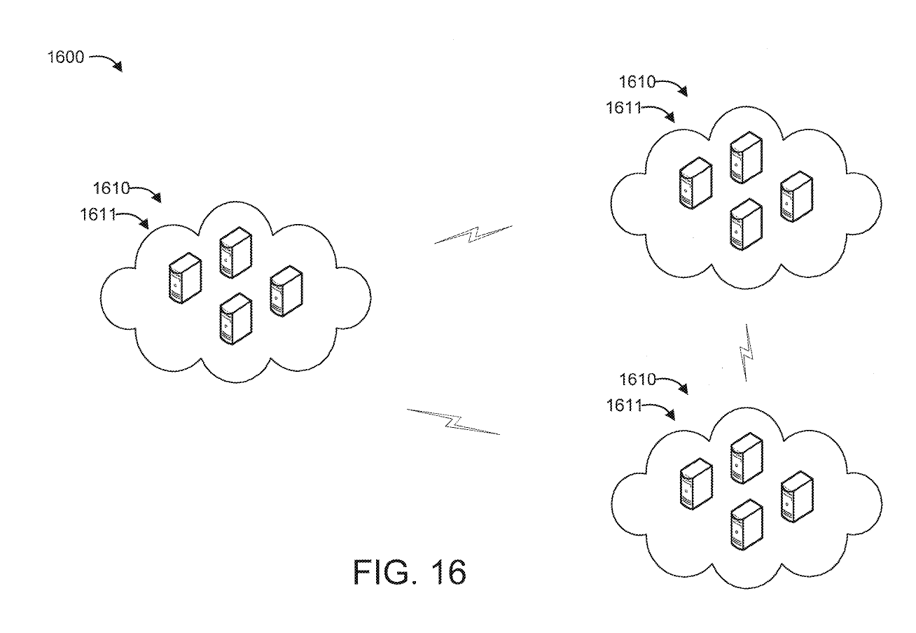

FIG. 16 shows a block diagram of an exemplary environment 1600 to which the present invention can be applied, in accordance with an embodiment of the present invention. The environment 1600 is representative of an invariant computer network to which the present invention can be applied. The elements shown relative to FIG. 2 are set forth for the sake of illustration. However, it is to be appreciated that the present invention can be applied to other network configurations as readily contemplated by one of ordinary skill in the art given the teachings of the present invention provided herein, while maintaining the spirit of the present invention.

The environment 200 at least includes a set of nodes, individually and collectively denoted by the figure reference numeral 210. Each of the nodes 210 can include one or more servers or other types of computer processing devices, individually and collectively denoted by the figure reference numeral 211. The computer processing devices 211 can include, for example, but are not limited to, machines (e.g., industrial machines, assembly line machines, robots, etc.) and so forth. For the sake of illustration, each of the nodes 210 is shown with a set of servers 211. Each of the nodes generates and/or otherwise provides time series data.

In an embodiment, the present invention performs invariant modeling and detection for heterogeneous logs, as described herein. Based on the ranks, a computer processing system can be controlled in order to mitigate errors stemming from propagation of an anomaly.

In the embodiment shown in FIG. 2, the elements thereof are interconnected by a network(s) 201. However, in other embodiments, other types of connections can also be used. Additionally, one or more elements in FIG. 2 may be implemented by a variety of devices, which include but are not limited to, Digital Signal Processing (DSP) circuits, programmable processors, Application Specific Integrated Circuits (ASICs), Field Programmable Gate Arrays (FPGAs), Complex Programmable Logic Devices (CPLDs), and so forth. These and other variations of the elements of environment 200 are readily determined by one of ordinary skill in the art, given the teachings of the present invention provided herein, while maintaining the spirit of the present invention.

A description will now be given regarding specific competitive/commercial values of the solution achieved by the present invention.

The present invention significantly reduces the complexity of performing invariant analysis among heterogeneous logs, even when prior knowledge about the system might not be available. By integrating advanced text mining and time series analysis in a novel way, the present invention provides an automated method that converts heterogeneous logs into multiple time series and then fuses these time series into multi-dimensional time series by time window generation and resampling. The resulting multi-dimensional time series enables invariant analysis over heterogeneous logs, and allows efficient anomaly detection based invariant models.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method performed in a network having a plurality of nodes that generate heterogeneous logs including performance logs and text logs, the method comprising:
performing, by a processor during a heterogeneous log training stage, (i) a log-to-time sequence conversion process for transforming clustered ones of training logs, from among the heterogeneous logs, into a set of time sequences that are each formed as a plurality of data pairs of a first configuration and a second configuration based on cluster type, (ii) a time series generation process for synchronizing particular ones of the time sequences in the set based on a set of criteria to output a set of fused time series, and (iii) an invariant model generation process for building invariant models for each time series data pair in the set of fused time series; and
controlling, by the processor, an anomaly-initiating one of the plurality of nodes based on an output of the invariant models.

2. The method of claim 1, wherein the log-to-time sequence conversion process comprises a log schema recognition process and a per-cluster time sequence generation process.

3. The method of claim 2, wherein the log schema recognition process comprises:
performing a tokenization process on the heterogeneous logs to generate tokens;
performing a log similarity process on the heterogeneous logs based on the tokens to identify log similarities amongst the heterogeneous logs; and
clustering the heterogeneous logs based on the log similarities.

4. The method of claim 2, wherein the per-cluster time sequence generation process comprises, for the performance logs, forming in the first configuration each of the plurality of data pairs to consist of a time stamp field value and a number field value.

5. The method of claim 2, wherein the per-cluster time sequence generation processes comprises, for the text logs, forming in the second configuration each of the plurality of data pairs to consist of a time stamp field value and a value indicating that a text log type occurs once at a time represented by the time stamp field value.

6. The method of claim 1, wherein the time series generation process comprises:
performing a time window generation process that partitions a time domain into a plurality of disjoint time windows of equal size and duration; and
resampling the time sequences in the set in accordance with the plurality of disjoint time windows.

7. The method of claim 6, wherein said resampling step comprises:
transforming the time sequences in the set output from a performance log cluster into transformed time sequences each having a plurality of transformed of data pairs that include a window end time point and a linear interpolated sequence-based value; and
transforming the time sequences in the set output from a text log cluster of a log schema into transformed time sequences each having a plurality of transformed of data pairs that include a window end time point and a number of log messages matching the log schema within a corresponding one of the plurality of time windows.

8. The method of claim 1, wherein the set of criteria, used by the time series generation process to determine the particular ones of the time series in the set to synchronize, comprises a common sampling time and a common frequency.

9. The method of claim 1, wherein the invariant model generation process comprises merging the fused time series in the set to form a multi-dimensional time series, and wherein the invariant models are built from the multi-dimensional time series.

10. The method of claim 1, further comprising repeating, by the processor during a heterogeneous log testing stage involving testing logs in place of the training logs, (i) the log-to-time sequence conversion process and (ii) the time series generation process, in order to test the invariant models.

11. The method of claim 1, further comprising performing, by a processor during a heterogeneous log testing stage, an invariant model testing process for testing the invariant models based on correlation mismatches in correlation patterns learned from the heterogeneous log training stage.

12. A computer program product for invariant model formation for a network having a plurality of nodes that generate heterogeneous logs including performance logs and text logs, the computer program product comprising a non-transitory computer readable storage medium having program instructions embodied therewith, the program instructions executable by a computer to cause the computer to perform a method comprising:
performing, by a processor during a heterogeneous log training stage, (i) a log-to-time sequence conversion process for transforming clustered ones of training logs, from among the heterogeneous logs, into a set of time sequences that are each formed as a plurality of data pairs of a first configuration and a second configuration based on cluster type, (ii) a time series generation process for synchronizing particular ones of the time sequences in the set based on a set of criteria to output a set of fused time series, and (iii) an invariant model generation process for building invariant models for each time series data pair in the set of fused time series; and
controlling, by the processor, an anomaly-initiating one of the plurality of nodes based on an output of the invariant models.

13. The computer program product of claim 12, wherein the log-to-time sequence conversion process comprises a log schema recognition process and a per-cluster time sequence generation process.

14. The computer program product of claim 13, wherein the log schema recognition process comprises:
performing a tokenization process on the heterogeneous logs to generate tokens;
performing a log similarity process on the heterogeneous logs based on the tokens to identify log similarities amongst the heterogeneous logs; and
clustering the heterogeneous logs based on the log similarities.

15. The computer program product of claim 13, wherein the per-cluster time sequence generation process comprises, for the performance logs, forming in the first configuration each of the plurality of data pairs to consist of a time stamp field value and a number field value.

16. The computer program product of claim 13, wherein the per-cluster time sequence generation processes comprises, for the text logs, forming in the second configuration each of the plurality of data pairs to consist of a time stamp field value and a value indicating that a text log type occurs once at a time represented by the time stamp field value.

17. The computer program product of claim 12, wherein the time series generation process comprises:
performing a time window generation process that partitions a time domain into a plurality of disjoint time windows of equal size and duration; and
resampling the time sequences in the set in accordance with the plurality of disjoint time windows.

18. The computer program product of claim 17, wherein said resampling step comprises:
transforming the time sequences in the set output from a performance log cluster into transformed time sequences each having a plurality of transformed of data pairs that include a window end time point and a linear interpolated sequence-based value; and
transforming the time sequences in the set output from a text log cluster of a log schema into transformed time sequences each having a plurality of transformed of data pairs that include a window end time point and a number of log messages matching the log schema within a corresponding one of the plurality of time windows.

19. The computer program product of claim 12, wherein the set of criteria, used by the time series generation process to determine the particular ones of the time series in the set to synchronize, comprises a common sampling time and a common frequency.

20. A computer processing system for invariant model formation for a network having a plurality of nodes that generate heterogeneous logs including performance logs and text logs, the computer processing comprising:
a processor configured to:
perform, during a heterogeneous log training stage, (i) a log-to-time sequence conversion process for transforming clustered ones of training logs, from among the heterogeneous logs, into a set of time sequences that are each formed as a plurality of data pairs of a first configuration and a second configuration based on cluster type, (ii) a time series generation process for synchronizing particular ones of the time sequences in the set based on a set of criteria to output a set of fused time series, and (iii) an invariant model generation process for building invariant models for each time series data pair in the set of fused time series; and
control an anomaly-initiating one of the plurality of nodes based on an output of the invariant models.
